(19) United States
(12) Patent Application Publication
(10) Pub. No.: US 2022/0143840 A1
(43) Pub. Date: May 12, 2022

(54) DRIVE SYSTEM

(71) Applicant: Festo SE & Co. KG, Esslingen (DE)

(72) Inventors: Simon Markowski, Esslingen (DE); Marc Hauck, Poing (DE)

(21) Appl. No.: 17/434,620

(22) PCT Filed: Feb. 28, 2020
(86) PCT No.: PCT/EP2020/055233

§ 371 Date: Aug. 27, 2021

(30) Foreign Application Priority Data
Mar. 4, 2019 (DE) 10 2019 202 898.5

(51) Int. Cl. B25J 13/08; F16K 31/00; F04B 49/06; F04B 49/22

(52) U.S. Cl. CPC B25J 13/088; F16K 31/004; B25J 9/042; F04B 49/22; F04B 49/06

(57) ABSTRACT

A drive system (1) which is designed in particular as a robot (1a) and which has a fluid-operated linear drive (2), on the drive unit (7) of which linear drive, which drive unit can be driven so as to perform a drive movement (8), there is mounted an electrically and fluidically operable working unit (3). The linear drive (2) is equipped with a control valve device (16) which can be actuated by means of an internal electronic control device (32) in order to move the drive unit (7). Two drive pressure sensor devices (113) and a travel measuring device (114) are connected to the internal electronic control device (32), such that a position-controlled operation of the drive unit (8) is possible. The drive system (1) furthermore includes a flexible electrical cable arrangement (97) and a flexible fluid hose arrangement (95), which are fixed to the drive unit (7) and which serve for the supply of electricity and fluid to the working unit (3).

The invention relates to a drive system, comprising a linear drive which has a drive housing and a drive unit which is displaceable with respect to this in the axis direction of a longitudinal axis of the linear drive whilst carrying out a linear drive movement and is positionable in different stroke positions, wherein the drive unit comprises a driven section which is accessible outside the drive housing, moves along a linear stroke path given the drive movement and comprises an assembly interface which is designed for the attachment of a working unit which can be linearly displaced by the drive movement of the drive unit.

A drive system of this type which is known from GP 2481249 A is designed as a SCARA robot and comprises a vertically aligned linear drive with a drive unit which can be driven into a vertical drive movement. The linear drive is of an electrically actuatable type and as a drive source comprises an electrical direct drive. The drive unit has a driven section which is arranged outside the drive housing and on which a working unit which functions as a robot arm is arranged. The working unit can be positioned in different working positions by way of the drive movement of the drive unit. The working unit comprises several electronic actuator devices which are formed by electrical rotary drives and function as active joints of the robot arm.

U.S. Pat. No. 6,068,442 discloses a SCARA robot with a robot arm which is pivotable in a horizontal plane and which on its outer end carries a vertically displaceable tube body which is equipped with an electric motor and a driven shaft which can be driven by the electric motor.

A robot which comprises a base mount with a vertically displaceable carriage is known from DE 10 2016 222 255 B3, wherein a horizontally projecting robot arm which comprises several joints is attached to the carriage. The carriage and thus the robot arm can be positioned in their height position by an electric motor.

EP 1 125 693 A1 describes a parallel-kinematic system with several vertically aligned linear drives which each comprise a vertically displaceable runner, wherein an end effector is arranged on the several runners via a linkage. The linear drives are fluidically actuatable and comprise position detection means for detecting the position of the assigned runner for the purpose of a desired positioning of the end effector.

DE 10 2017 215 942 A1 describes a robot of the SCARA type which comprises a base and a joint arm which is pivotable with respect to the base and which is subdivided by way of at least one arm link into several arm links which are pivotable relative to one another.

DE 199 34 965 A1 describes a robot with multi joint arms which are movable in a horizontal plane. A robot body has a cylindrical holder which is movable in the vertical direction and on which a first arm is attached, to which first arm in turn a movable second arm is connected.

A handing apparatus unit which comprises a movable holding device which holds a main cylinder which is designed as a piston-rod-free cylinder which comprises a force output member which is connected to the holding device is described in DE 33 39 227 A1.

US 2017/0217013 A1 describes a device with a tower which is covered by a shell, wherein the tower comprises a base with a first movement axis for a movement about a first joint, a first arm which is connected to the tower along a second movement axis via a second joint, and a second arm which is connected to the first arm at the proximal end of the second arm via a third joint. The second arm has an end effector interface which is configured such that it can hold a multitude of end effectors which are suitable for different applications.

US 2010/0163694 A1 describes a stand with an arm which is vertically movably mounted on a vertical column via a vertical guide, for holding an object, wherein a counter-weight which compensates the weight of the arm is provided on or in the vertical column Furthermore, a device for moving the counter-weight counter to the weight force for an at least partial lifting of the weight compensation is present.

U.S. Pat. No. 4,566,847 A describes a positioning device for the positioning of a robot arm of an industrial robot which comprises a frame element which is connected to the robot arm and is movably carried by a frame carrier element. A rotation motor can create a drive movement of the frame carrier element with regard to rotation angle, and a linear motor can create a linear drive movement of the frame carrier element. By way of this, the robot arm can be positioned in an accurate manner.

It is the object of the invention to provide a drive system which given an inexpensive construction and compact dimensions permits an exact variable positioning of a working unit which in particular can be used as a robot arm.

For achieving this object, a drive system according to the invention additionally to the aforementioned features is characterised in

(a) that the linear drive is a double-acting fluid-actuated linear drive whose drive unit comprises a drive piston which is arranged in the drive housing, is coupled in movement to the driven section and in the drive housing axially divides off two drive chambers from one another, said drive chambers being able to be subjected to a fluidic pressure medium in a controlled manner for moving and positioning the drive unit,

(b) that an electrically actuatable control valve device is arranged on the drive housing of the linear drive, said control valve device being designed for the controlled fluid subjection of the two drive chambers and on the one hand being in fluid connection with the two drive chambers of the linear drive each via a drive channel and on the other hand for the receiving and delivery of a fluid pressure medium communicating with a fluidic main connection device, said main connection device comprising a main fluid supply connection which is provided for connection to a pressure source and a main fluid delivery connection which is provided for connection to a pressure sink,

(c) that an internal electronic control device of the drive system which is electrically connected to the control valve device for control purposes is arranged on the drive housing of the linear drive,

(d) that two drive pressure sensor devices which are designed for detecting the fluid pressure which prevails in the two drive chambers and which for the transmission of electrical pressure signals are electrically connected to the internal electronic control device are present,

(e) that the linear drive is provided with a displacement measuring device which is suitable for detecting the momentary actual stroke position of the drive unit and which for the transmission of electrical position signals is electrically connected to the internal electronic control device,

(f) that the internal electronic control device comprises a closed-loop control electronics, by way of which the control valve device can be electrically controlled in a closed-loop controlled manner with respect to pressure for the actuation of the drive unit in a closed-loop controlled manner with respect to position, whilst taking into account the position signals which are delivered by the displacement measuring device and the pressure signals which are delivered by the two drive pressure sensor devices,

(g) that a bending-flexible electricity cable arrangement is connected onto the internal electronic control device, said electricity cable arrangement being designed for the electricity-transmitting electrical connection of the internal electric control device to at least one electrical actuator device of the working unit, said working unit being fastened to the assembly interface, and

(h) that a bending-flexible fluid tube arrangement which is designed for the fluid-transmitting fluidic connection of the fluidic main connection device to at least one fluidic actuator device of the working unit is connected onto the fluidic main connection device, said working unit being fastened to the assembly interface.

The drive system according to the invention permits a rapid and exact positioning of a working unit which is provided with fluidic and electrical actuator devices, in combination with a reliable fluidic and electrical communication between components of the working unit and stationary components which are positionally fixed with respect to the drive housing. The fluid-actuated linear drive has a drive unit, to which the working unit to be positioned is attached or can be attached and which comprises a drive piston which is arranged in a drive housing, in order by way of fluid subjection to create a linear drive movement of the drive unit. The drive piston divides off two drive chambers from one another in the drive housing, said drive chambers both being subjectable to a fluidic pressure medium in a controlled manner, for which purpose an electrically actuatable control valve device which communicates with the two drive chambers is arranged on the drive housing in a direct or indirect manner The fluidic pressure medium is preferably pressurised air. The control valve device is electrically connected onto an internal electronic control device of the drive system, by way of which it is electrically controllable, so that a movement of the drive unit which is closed-loop controlled in position is possible. The internal electronic control device comprises closed-loop control electronics which process the position signals of a displacement measuring system and pressure signals of two drive pressure sensor devices, in order to control the control valve device such that the drive unit is displaced and positioned in closed-loop-controlled manner with regard to position in the context of a closed-loop control of the pressure of the two drive chambers. The feed and discharge of the fluidic pressure medium which is necessary for actuation is effected via a connection device which for the purpose of a better differentiation is denoted as a main connection device and onto which the control valve device is connected and which for its part is connected to a pressure source and to a pressure sink in the operationally ready state of the drive system. The pressure source provides the fluidic pressure medium, with regard to which in particular it is pressurised air. The atmosphere functions as a pressure sink, wherein a liquid reservoir which is at atmospheric pressure is used in the case of a fluidic pressure medium.

Two pressure sensor devices which for the better differentiation are denoted as drive pressure sensor devices and which can each detect the fluid pressure prevailing in one of the two drive chambers and are each connected for example onto a drive channel which fluidically connects the control valve device to one of the drive chambers are present for the closed-loop control of the pressure. A displacement measuring device which is arranged on the linear drive is capable of detecting the momentary actual stroke position of the drive unit and transmitting it to the internal electronic control device, to which the electrical pressure signals of the drive pressure sensor devices are also fed.

The drive system is provided with a bending-flexible electricity cable arrangement and with a bending-flexible fluid tube arrangement for the fluidic and electrical supply of a working unit which is assembled on the drive unit. The electricity cable arrangement ensures an electrical connection of electrical components of the working unit to the internal electronic control device. The electrical current is transmitted for example as pure operation energy and/or in the form of electrical control signals. Fluidic actuator devices of the working unit, just as the control valve device can be connected onto the fluidic main connection device via the fluid tube arrangement, in order to receive or discharge the fluidic pressure medium which is necessary for operation. On account of its bending flexibility, the electricity cable arrangement and the fluid tube arrangement can follow the linear travel movement of the working unit without any damage.

On account of the equipping with a control valve device, with pressure sensors, with a displacement measuring system, with closed-loop control electronics and with fluid and electricity transmission means for the supply of a working unit which is fastened to the drive device, the linear drive has a functional integration with a high function density which optimises the conditions for compact dimensions, high positioning speeds and an exact positioning behaviour.

Advantageous further developments of the invention are to be derived from the dependent claims

The drive system expediently comprises a working unit which is attached to the assembly interface of the drive unit and which comprises at least one fluidic actuator device which can be actuated by fluid force and at least one electrically actuatable electrical actuator device. The fluidic actuator device is connected onto the bending-flexible fluid tube arrangement and the electrical actuator device onto the bending-flexible electricity cable arrangement.

Concerning at least one fluidic actuator device of the working unit, it is preferably a fluid-actuated rotary drive. Such a fluid-actuated rotation device in particular is suitable for forming an active joint within a working unit which is designed as a robot arm.

At least one electrical actuator device of the working unit is expediently formed by a valve or a valve drive of a control valve device of the working unit. Hence at least one electrical actuator device can directly form a valve of the control valve device which can be electrically actuated in a direct manner Moreover, at least one electrical actuator device can be for example an electrically actuatable pilot valve of a pilot-operated control valve device. For example a magnet valve and in particular a piezo-valve is considered as a pilot valve or valve.

Preferably, the drive system comprises an interface module which is fastened to the assembly interface of the drive unit and which is designed for the mechanical connection to the working unit and which preferably also comprises interfaces for the fluid tube arrangement and/or for the electricity cable arrangement which permit a transmission of energy. The interface module in particular is designed such that fluidic and electrical energy which is required by the working unit can be led through the interface module. For example, the interface module comprises fluid transmission channels and at least one electricity transmission channel, wherein the fluid transmission channels are designed for directly leading through the fluidic pressure medium and the at least one electricity transmission channel for leading through at least one electricity cable.

As already mentioned, it is considered as being particularly advantageous if the double-acting liner drive is designed as a pneumatic linear drive which is operated with pressurised air.

In this manner, particularly high accelerations and travel speeds of the drive unit can be realised. Notwithstanding, the desired stroke positions can be moved to in an extremely target-accurate manner on account of the closed-loop control of the pressure which can be carried out by the closed-loop control electronics. On account of the closed-loop control of the pressure in combination with compressible pressurised air as a pressure medium, there is also the advantageous possibility of influencing the stiffness of the drive system and of imparting a certain compliance for avoiding dangerous situations.

The linear drive is preferably a linear drive without a piston rod, so that its construction length does not change during operation. The drive system can be designed such that the working unit which is fastened to the assembly interface is always located next to the drive housing of the linear drive.

The drive housing preferably has a housing tube which is provided with a longitudinal slot, wherein the drive piston is mechanically coupled in movement to the driven section via a driver which passes through the longitudinal slot. Alternatively, one can also fall back on a peripherally closed housing tube if the coupling with regard to drive, between the drive position and the driven section, is realised in a contact-free manner via a permanent magnetic magnet arrangement.

Basically, the drive system can also be realised with a linear drive which comprises a piston rod. However, it this case it is advantageous to provide additional guides which accommodate the transverse loadings which originate from the working unit to be moved.

The drive system is preferably provided with a support device which is flexible transversely to its longitudinal direction and through which the bending-flexible electricity cable arrangement and the bending-flexible fluid tube arrangement are led. The electricity cable arrangement and the fluid tube arrangement are held in a controlled manner by the support device and are thus protected from damage. The flexible support device can consist for example of an elastic, helical spiral structure which can be axially spread in the manner of a spiral spring. However, a design as a drag chain is seen as being particularly expedient, and this on the one hand is fixed in a stationary manner with respect to the drive housing and on the other hand in a stationary manner with respect to the driven section of the drive unit.

The drive system can be designed for an autarkic operating manner. In this case, all operating sequences are controlled by the internal electronic control device of the drive system. The internal electronic control device can comprise an integrated, preferably variable control program, by way of which the desired movement sequences can be specified. If the drive system operates in combination with at least one further drive system or other electronically controllable system components, it is advantageous if the internal electronic control device comprises an electronic communication interface which permits a connection to an external electronic control device which operates as a superordinate control device. In particular, one envisages the respectively desired stroke position of the drive unit being able to be specified externally via the electrical communication interface.

The control valve device can have for example an electromagnetic functioning principle. However, a design as a piezoelectric control valve device which has a plurality of electrically controllable piezo-valves is preferred. The piezo-valves as an actuator unit in particular comprise a piezoelectric bending transducer. Since piezo-valves as a rule require a high operating voltage, it is expedient if a high-voltage stage for generating a high voltage operating voltage for the piezo-valves is integrated into the internal electronic control device.

The control valve device is preferably divided up functionally and structurally, so that it comprises two separate control valve units which are each responsible for the control of the fluid subjection of one of the two drive chambers of the linear drive. Each control valve unit is expediently seated in the region of that axial housing end section of the drive housing which is assigned to the drive chamber to be controlled. Herein, each control valve unit communicates with one of the already mentioned drive channels which each run out into one of the two drive chambers. The drive channels are expediently integrated into the drive housing of the linear drive.

It is particularly advantageous if a control of the feed and the discharge of the fluidic pressure medium which is independent of one another with respect to the assigned drive chamber can be carried out by each control valve unit. For this, it is expedient if each control valve unit comprises an electrically actuatable supply valve unit for the control of the fluid feed to the connected drive chamber and an electrically actuatable delivery valve unit for the control of the fluid delivery out of the connected drive chamber. These valve units each have a 2/2-way valve function so that they neither permit nor prevent a fluid passage. They can be controlled by the internal electronic control device such that a 3/3-way valve function can be realised. By way of this, amongst other things it is possible to separate each drive chamber from the pressure source as well as from the pressure sink, in order to shut in a contained fluid volume and to block the drive unit in an immovable manner.

The internal electronic control device is preferably constructed in a modular manner and comprises several control modules, upon which various control and/or closed-loop control functions can be divided. The internal electronic control device preferably comprises a main control module and a supplementary control module which is separate with respect to this and which is electrically connected to the main control module, wherein the closed-loop control electronics and the already mentioned optional high voltage stage are contained in the supplementary control module. The main control module can serve for example to control the electrical actuator units of the drive unit via the bending-flexible electricity cable arrangement, this being irrespective of the fact that the working unit can indeed also comprise individual electronic control units which communicate with the main control module.

The bending-flexible electricity cable arrangement preferably comprises only a single bus cable, which in particular corresponds to the CAN bus standard and which coming from the main control module extends at least up to the driven section of the drive unit or up to an interface module which is assembled thereto. This bus cable however preferably runs in a continuous manner up to the working unit which is assembled on the drive unit. Expediently, the electricity cable which is designed as a bus cable for series signal transmission is led through the optional supplementary control module.

It is expedient if the drive system additionally comprises at least one supply pressure sensor device which is capable of detecting the supply pressure of the fluidic pressure medium which is fed to the control valve device from the main connection device. In this manner, one can constantly control whether an adequately high supply pressure is available. If the supply pressure differs from the desired pressure, then the internal electronic control device, onto which the supply pressure sensor device is connected can output a warning signal or switch the drive system into a safety mode and/or completely switch it off.

Expediently a fluid delivery pressure sensor device is applied as a further safety aspect, said fluid delivery pressure sensor device detecting the fluid delivery pressure of the fluidic pressure medium which is delivered from the control valve device to the main connection device and transmitting the respective pressure signals to the internal electronic control device. In this manner, given a pneumatic system, one can constantly examine whether the deventing function is correctly available or whether possible contaminations are present, for example in sound absorbers, which manifest themselves in a rising dynamic pressure. Here too, given problematic measurement values, the internal electronic control device can initiate suitable actions comparable to those given a drop of the supply pressure.

One advantageous application case for the drive system is the use as a robot, in particular as a so-called SCARA robot. In this case, the linear drive in particular is installed with a vertically orientated longitudinal axis, so that the drive movement of the drive unit and consequently also the working movement of the working unit which is assembled thereon is a vertical movement. Expediently, the linear drive in this case is fixed with the downwardly facing end region of its drive housing to a base structure which is formed by way of example by a table plate or by a base plate.

The invention is hereinafter explained in more detail by way of the accompanying drawings. In these are shown in:

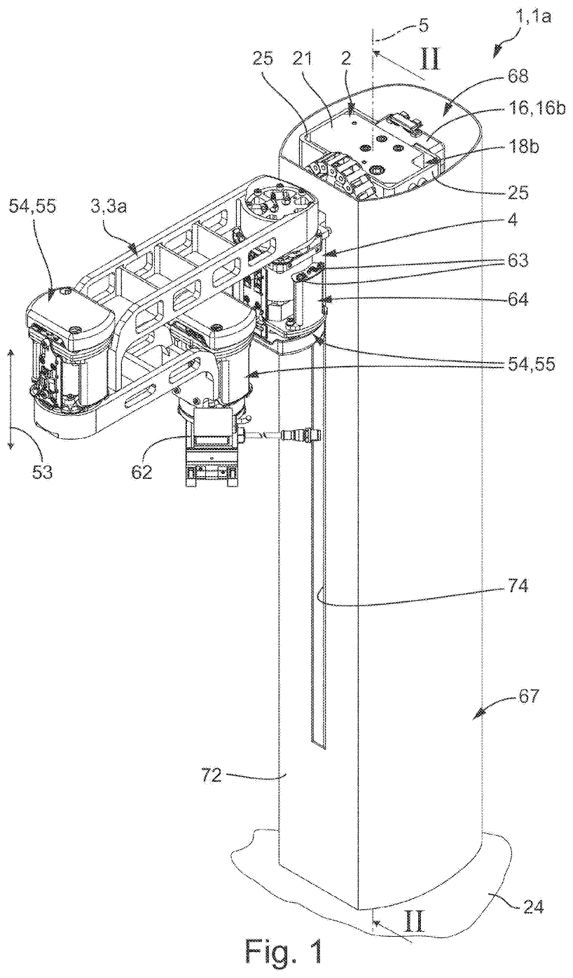

FIG. 1 an isometric representation of a preferred embodiment of the drive system according to the invention, in the design as a SCARA robot,

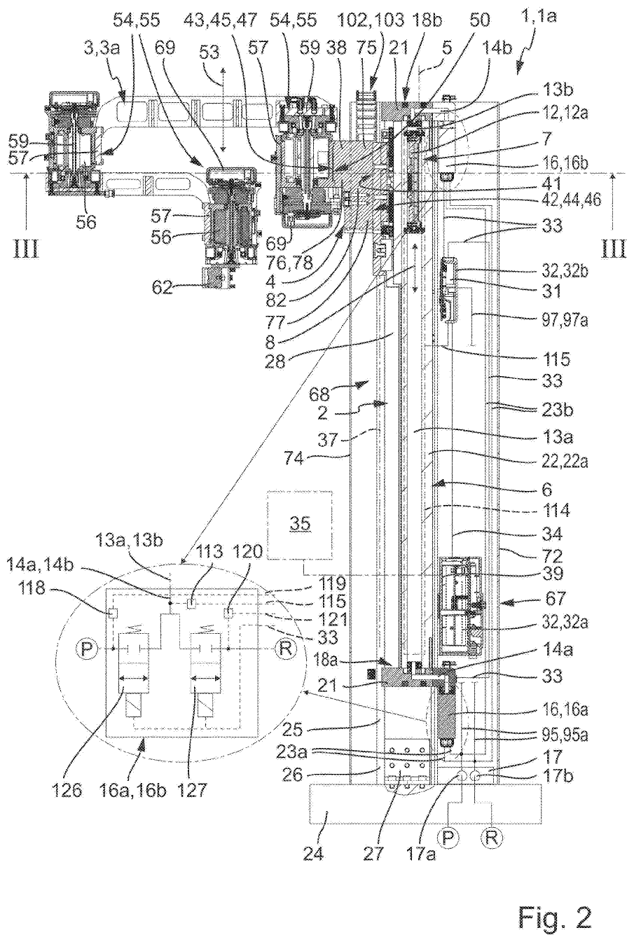

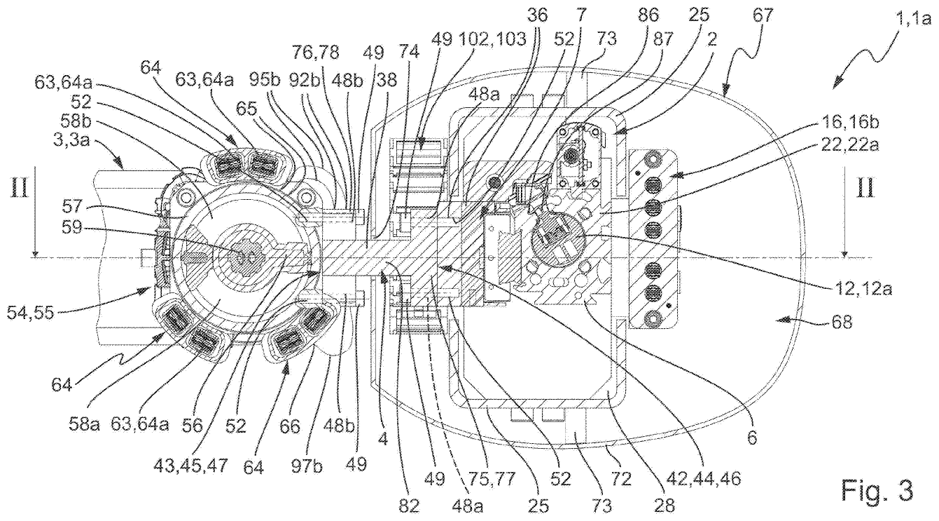

FIG. 2 the drive system of FIG. 2 in a longitudinal section according to section line II-II of FIGS. 1 and 3, wherein the internal construction of the two control valve units which are framed in a dot-dashed manner is illustrated in a schematic enlargement,

FIG. 3 a cross section of the drive system according to section line of FIG. 2,

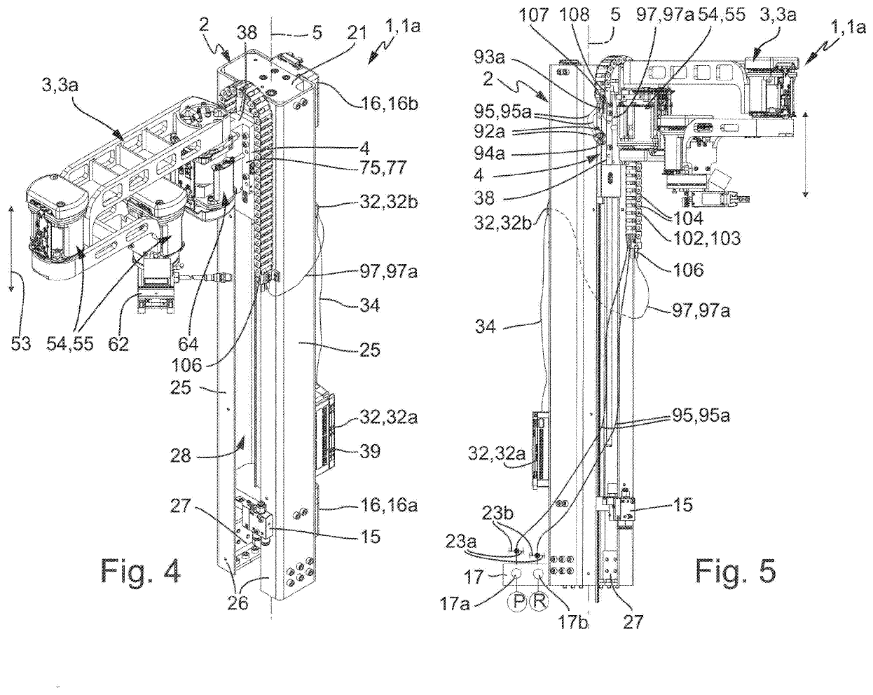

FIG. 4 a further isometric representation of the drive system, without illustration of an optionally present enveloping body which envelops the linear drive,

FIG. 5 the arrangement of FIG. 4 from another viewing angle and

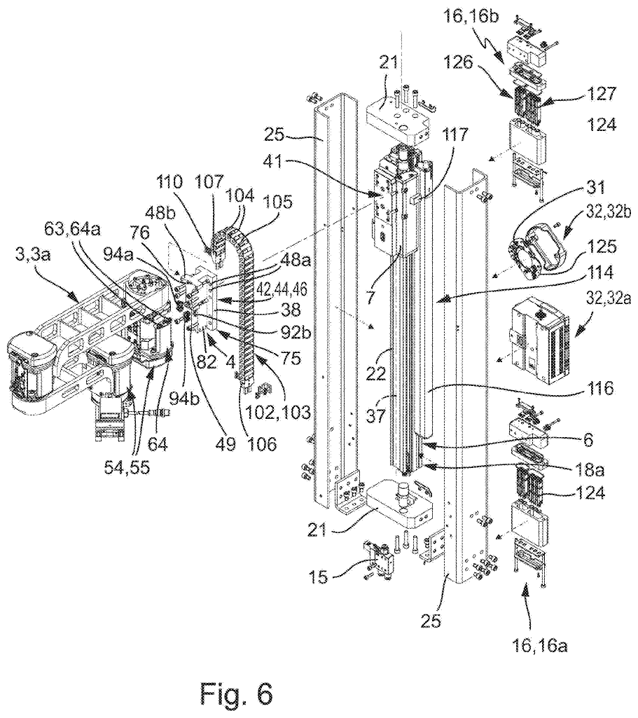

FIG. 6 an exploded representation of the drive system in the embodiment of FIG. 4 and again without the optional enveloping body.

The drive system which is denoted in its entirety with the reference numeral 1 comprises a linear drive 2 and in particular also an electro-fluidic working unit 3 which is movable and positionable by the linear drive 2. The working unit 3 is expediently fastenable or fastened to the linear drive 2 via an interface module 4 which likewise belongs to the drive system 1.

The linear drive 2 has a longitudinal axis 5 and in the preferred application case which is illustrated in the drawing is arranged such that the longitudinal axis 5 is aligned vertically. The further explanation relates to this preferred application case, wherein it should be mentioned that the linear drive 2 in principle can also be integrated into the drive system 1 at any other spatial alignment.

The axis direction of the longitudinal axis 5 is hereinafter also denoted as the longitudinal direction 5 of the linear drive whilst using the same reference numeral.

The linear drive 2 has a drive housing 6 which extends in the longitudinal direction 5 and a drive unit 7 which is movable relative to the drive housing 6 in the longitudinal direction 5. The linear movement which can be orientated in both axis directions of the longitudinal axis 5 and which can herein be carried out by the drive unit 7 is hereinafter denoted as the drive movement 8.

The drive unit 7 has a drive section 12 which is linearly movably arranged in the inside of the drive housing 6 and upon which a drive force can be exerted, in order to generate the drive movement 8. The drive section 12 is formed by a drive piston 12a which axially subdivides the interior of the drive housing 6 into two drive chambers 13a, 13b which are hereinafter also denoted as the first and second drive chambers 13a, 13b. Given the exemplary alignment of the linear drive 2, the second drive chamber 13b lies above the first drive chamber 13a.

An individual drive channel 14a, 14b runs out into each drive chamber 13a, 13b, through which drive channel the assigned drive chamber 13a, 13b can be subjected to a fluidic pressure medium in a controlled manner, in order to generate a drive force which acts upon the drive piston 12a and from which the drive movement 8 results. The relative positions with respect to the drive housing 6 which are passed through by the drive unit 3 in the course of the drive movement 8 are denoted as stroke positions. On account of the pressure subjection of the two drive chambers 13a, 13b which is matched to one another, the drive unit 7 can be fixedly held which is to say positioned in any arbitrary stroke position.

The linear drive 2 is therefore a double-acting fluid-actuated linear drive 2. The drive piston 12a for its actuation can be actively impinged with fluidic pressure medium in both axial directions for its actuation. The drive piston 12a and consequently the complete drive unit 8 can therefore be moved in both travel directions purely by way of a controlled fluid impingement of the two drive chambers 13a, 13b.

Optionally, the linear drive 2 can be provided with a locking brake, by way of which the drive unit 7 can be releasably fixed, which means blocked, in every arbitrary operating position by way of mechanical engagement. The braking function is expediently controlled by fluid pressure, wherein a brake control valve which is suitable for this is represented at 15.

The drive system 1 comprises an electrically actuatable control valve device 16 which is connected onto a fluidic connection device 17 which for the improved differentiation is denoted as a main connection device 17 and which for its part is connected to a pressure source P and to a pressure sink R on operation of the drive system 1.

The pressure source P provides a fluidic pressure medium which is suitable for actuating the linear drive 2, said pressure medium preferably being pressurised air. Its connection to the main connection device 17 in particular is realised by a tube connection. The linear drive 2 in this case is a pneumatic linear drive which is operated with pressurised air as a pressure medium.

The pressure sink R is preferably formed by the atmosphere. The connection of the main connection device 17 to the atmosphere is realised for example by a tube connection or by a sound absorber. Given a likewise possible operation by way of a pressurised fluid as a fluidic pressure medium, the pressure sink R is formed for example by a pressurised liquid reservoir which is under atmospheric pressure.

The main connection device 17 has a main fluid feed connection 17a which can be used for connection to the pressure source P and a main fluid delivery connection 17b which can be used for connection to the pressure sink. The control valve device 16 is connected to the main connection device 17 via connection units which are not illustrated further and through the main connection device 17 to the main fluid feed connection 17a and to the main fluid delivery connection 17.

The control valve device 16 is designed such that each drive channel 14a, 14b can be selectively connected to the main fluid feed connection 17a or to the main fluid delivery connection 17b. The control valve device 16 is preferably also in the position of simultaneously separating the drive channel 14a, 14b which is assigned to it, from both connections 17a, 17b, in order to block the pressure medium which is contained in the assigned drive chamber 13a, 13b.

Preferably and corresponding to the illustrated embodiment example, the control valve device 16 comprises two separate control valve units 16a, 16b, wherein a first control valve unit 16a controls the first drive channel 14a which is connected to the first drive chamber 13a, whereas the second control valve unit 16b is capable of controlling the second drive channel 14b which is connected to the second drive chamber 13b. Both control valve units 16a, 16b are designed in an electrically actuatable manner They are preferably actuated in a direct electrical manner, but they can also be of a pilot construction type.

The drive housing 6 has two end sections 18a, 18b which are opposite to one another. A first housing end section 18a by way of example faces downwards, whereas a second housing end section 18b faces upwards. Expediently, a housing cover 21 of the drive housing 6 is located on each of the two housing end sections 18a, 18b, wherein a housing tube 22 of the drive housing 6 extends between the two housing covers 21, said housing tube forming a peripheral housing wall 22a of the drive housing 6 which encompasses the two drive chambers 13a, 13b.

Expediently, the first control valve unit 16a is fastened to the first housing end section 18a whereas the second control valve device 16b is fastened to the second housing end section 18b. The control valve units 16a, 16b are preferably constructed on the drive housing 6 laterally at the outside, wherein they are fastened in particular to the respectively assigned housing cover 21.

The first control valve unit 16a is connected via first valve connection channels 23a onto the main fluid feed connection 17a and onto the main fluid delivery connection 17b. The same connections 17a, 17b are connected onto the second control valve unit 16b via two valve connection channels 23b. The valve connection channels 23a, 23b can each be designed as bore-like fluid channels and/or as channels in fluid conduits or fluid tubes.

The fluidic main connection device 17 is placed by way of example in the region of the first housing end section 18a. In this case, the second valve connection channels 23b which with the embodiment example are formed by external fluid tubes can be designed completely or partially as fluid channels which extend in the wall of the drive housing 6.

The linear drive 2 is preferably fastened to a base structure 24 for setting an alignment in accordance with operation. The base structure 24 can for example be a base plate or a tabletop. Two fastening struts 25 which extend longitudinally next to the drive housing 6 and on which the drive housing 6 is fastened are arranged at the outside on the drive housing 6 of the linear drive 2, for the base-side fastening. The fastening is expediently effected to the two housing covers 21, onto which the fastening struts 25 are screwed by way of example with fastening screws 28.

The fastening struts 25 each with a fastening end section 26 project beyond the first housing end section 18a of the drive housing 6 and are releasably screwed to the base structure 24 via fastening brackets 27 or other fastening elements, or are fixedly connected in another manner.

The two fastening struts 25 are preferably each formed by a U-profile element and are arranged such that the U-openings face the drive housing 6. Since the fastening struts 25 furthermore lie diametrically opposite with respect to the longitudinal axis 5, together they delimit a receiving space 28, in which the drive housing 6 of the linear drive 2 extends. Expediently, the two housing covers 21 project radially beyond the housing tube 22 of the drive housing 6, wherein sections of the housing covers 21 project into the fastening struts 25 which are profiled in a U-shaped manner.

An internal electric control device 32 of the drive system 1, onto which control device the control valve device 16 is connected for receiving electrical control signals is responsible for the electrical control of the control valve device 16 which specifies the operating state of the linear drive 2. By way of example, several electrical control leads 33 are provided, by way of which the two control valve units 16a, 16b are connected onto the internal electronic control device 32.

The internal electronic control device 32 is arranged on the drive housing 6. By way of example, it is fastened directly to the drive housing 6 by way of it being attached to the fastening struts 25 which are fixedly connected to the drive housing 6. However, it can also be built onto the drive housing in a direct manner.

The internal electronic control device 32 is preferably subdivided into several control modules which are arranged distanced to one another and which by way of example comprise a main control module 32a and a supplementary control module 32b. The supplementary control module 32a is connected to the main control module 32a via an electric control lead 34. The control valve device 16 is expediently connected onto the supplementary control module 32b. The latter expediently contains or defines closed-loop control electronics 31 which in the context of a closed-loop control of the pressure of the fluid pressure which prevails in the drive chambers 13a, 13b permits an actuation of the drive unit 7 which is closed-loop controlled in its position.

The internal electronic control device 32 expediently has an electronic communication interface 39, by way of which a communication with an external electronic control device 35 which is only shown schematically is possible. The external electronic control device 35 for example specifies the desired stroke positions of the drive unit 7 which are taken into account by the closed-loop control electronics 31. Apart from the internal electronic control device 32 of the drive system 1, yet further systems whose operation which is matched to one another is coordinated by the external electronic control device 35 can be connected onto the external control device 35. The drive system 1 is preferably also capable of functioning in an autarkic manner without the external electronic control device 35.

The optional external electronic control device 35 is expediently a constituent of the drive system 1.

The drive unit 7 comprises a driven section 36 which is accessible outside the drive housing 6 and which is coupled in movement to the drive piston section 12 in a manner such that it synchronously participates in the linear drive movement 8. The driven section 36 given the drive movement 8 displaces along a linear displacement path which is to be denoted as a linear stroke path 37 and is illustrated in the drawing by a dot-dashed line. The driven section 36 is located partly or completely outside the drive housing 6.

The linear drive 2 is expediently of the rod-less type without a piston rod, which applies to the illustrated embodiment example Here, the linear stroke path 37 of the driven section 36 is located within the axial extension of the drive housing 6, so that the axial length of the linear drive 2 does not change given its use.

Concerning the preferred linear drive 2 of the embodiment example, the drive piston 12a and the driven section 36 are arranged at least essentially at the same axial height with respect to the longitudinal axis 5. A longitudinal slot 86 which extends in the longitudinal direction 5 passes radially through the housing tube 22 which forms a peripheral housing wall 22a of the drive housing 6, through which slot a driver section 87 of the drive unit 3 projects, said driver section coupling the drive piston 12a to the driven section 36 with regard to the drive. In this manner, the drive movement 8 is always executed in a unitary manner by the drive piston 12a, the driver section 87 and the driven section 36.

Concerning an embodiment example which is not illustrated, the housing tube 22 is closed all around and the coupling between the drive piston 12a and the driven section 36 with regard to drive is effected magnetically in a contact-free manner.

Basically, the linear drive 2 can also be designed as a linear drive with a piston rod which can be extended out of the drive housing.

The already mentioned interface module 4 has a preferably single-piece interface module body 38 which comprises a first mechanical fastening interface 42, via which it is fastened, in particular in a releasable manner, to an assembly interface 41 of the driven section 36 of the drive unit 7. By way of example, the first mechanical fastening interface 42 is located on a lower side 44 of the interface module body 38 which faces the drive housing 6.

The interface module body 38 furthermore has a second mechanical fastening interface 43, to which the working unit 3 is fastened with a further assembly interface 50, expediently likewise in a releasable manner The second mechanical fastening interface 43 is preferably located on an upper side 45 of the interface module body 38 which is opposite to the lower side 44.

The first mechanical fastening interface 42 preferably has a first assembly surface 46 with which with this in front the interface module body 38 is applied onto the driven section 36 of the drive unit 7 in the region of the assembly interface 41. The second mechanical fastening interface 43 expediently comprises a second assembly surface 47 which is away from the first assembly surface 46. The working unit 3 is applied with the further assembly interface 50 onto the second assembly surface 47.

Expediently, each mechanical fastening interface 42, 43 is designed for the screw fastening of the components which are attached thereto, thus of the driven section 36 and the working unit 3. In this context, the first mechanical fastening interface 42 comprises a plurality of first fastening holes 48a, whilst the second mechanical fastening interface 43 comprises a plurality of second fastening holes 48b. The fastening holes 48a, 48b run out to the respectively assigned first or second assembly surface 46, 47 and permit the leading-through of fastening screws 49 which on the one hand are supported with their screw head on the interface module body 38 and on the other hand are screwed into threaded bores 52 of the driven section 36 and of the working unit 3.

The hole pattern of the fastening holes 48a, 48b of the two fastening interfaces 42, 43 can be designed differently and in each case in accordance with requirements.

The working unit 3 which is fastened to the drive unit 7 via the interface module 4 participates in the drive movement 8 and carries out a linear working movement 53 which is oriented equally with regard to this. Hence the working unit 3 can be linearly displaced and positioned in accordance with requirements by way of a suitably controlled actuation of the linear drive 2 whilst carrying out the working movement 53.

The working unit 3 comprise at least one actuator device 54 which can be actuated by fluid force and which for the simplification is denoted as a fluid actuator device 54.

At least one and preferably each of the fluidic actuator devices 54 of the working unit 3 is expediently designed as a fluid-actuated drive, wherein by way of example a design as a fluid-actuated rotary drive 55 is present.

As in particular the FIGS. 2 and 3 illustrate, the fluid-actuated rotary drive 55 in particular is designed as a pivoting piston drive which comprises a pivotably mounted drive piston 56 which for the improved differentiation can be denoted as a pivoting piston 56 and which in a rotary drive housing 57 divides off two drive chambers 58a, 58b from one another. The pivoting piston 56 is fastened to a driven shaft 59 which is led out of the rotary drive housing 57. By way of a controlled fluid subjection of the two drive chambers 58a, 58b, the pivoting piston 56 can be driven into a pivoting movement with respect to the rotary drive housing 57, from which a rotational relative movement between the rotary drive housing 57 and the driven shaft 59 results.

According to the illustrated embodiment example, the drive system 1 is preferably designed as a robot la, wherein the working unit 3 represents a robot arm 3a of the robot 1a. Concerning the robot la, it is preferably a SCARA robot. Within the robot arm 3a, the fluid-actuated rotary drives 55 form active joints, by way of which the robot arm sections which are respectively attached to the rotary drive housing 27 and to the driven shaft 59 are actively pivotable relative to one another and are positionable relative to one another with regard to the rotation angle. By way of example, the robot arm 3a is provided with three fluid-actuated rotary drives 55 which function as joints. At least one such fluid-actuated rotary drive 55 can be designed as a carrier for an end-effector 62 of the robot 1a which is designed for example as a gripper.

Preferably, one of the fluid-actuated rotary drives 55 is fastened with its rotary drive housing 57 to the second mechanical fastening interface 43 of the interface module 4 in the manner which is described further above. The further assembly interface 50 is located on it. The driven shaft 59 which is rotatable with respect to this carries a pivotable robot arm section, on which a further fluid-actuated rotary drive 55 is seated. The design of the robot arm 3a is directed to the respective application demands.

The working unit 3 is also provided with at least one electrically actuatable actuator device 63 which is denoted as an electrical actuator device 63 for simplification.

By way of example, at least one and preferably each electrical actuator device 63 is designed as an electrically actuatable valve 64a of a control valve device 64 of the working unit 3 and is denoted as a working control valve device 64 for an improved differentiation.

The at least one working control valve device 64 by way of example serves for the fluidic control of at least one of the fluid-actuated rotary drives 55 and in this context is capable of controlling the feed and the discharge of a fluidic pressure medium with respect to the two drive chambers 58a, 58b of the fluid-actuated rotary drive 55. Expediently, at least one working control valve device 64 is assembled on the rotary drive housing 57 of each fluid-actuated rotary drive 55.

One or each valve 64a of the working control valve device 64 is preferably a piezo-valve, but however can also for example be a magnet valve. By way of example, each valve 64 directly controls the fluid feed or the fluid discharge of a fluidic pressure medium into and out of one of the drive chambers 58a, 58b.

Alternatively, one or each working control valve device 64 is of the electro-fluidic pilot construction type, wherein it has a valve main stage which can be actuated by a valve drive which operates as an electrically actuatable pilot valve, wherein the valve drive represents an electrical actuator device 63.

For receiving and the discharging the pressure medium which is necessary for the operation of the at least one fluidic actuator device 54, the working unit 3 is provided with at least one connection device which for an improved differentiation is denoted as a fluidic working connection device 65.

At least one electrical working connection device 66 of the working unit 3 is designed for the feed and preferably also for the discharge of an electrical current which is necessary as a provider for electrical energy and/or electrical control signals with regard to the at least one electrical actuator device 63. In this context, it is to be mentioned that the working unit 3, for the control of the fluidic actuator devices 54 can comprise at least one individual electronic working unit control unit 69 which can communicate with the internal electronic control device 62 via the electrical working connection device 66.

The drive system 1 as a further component preferably comprises an enveloping body 67 which encompasses the linear drive 2 at least peripherally, thus in its radial peripheral region. By way of this, the linear drive 2 is accommodated in a manner protected from environmental influences. Yet further constituents of the drive system 1, thus in particular the internal electronic control device 32 can be accommodated in the enveloping body interior 68 which is defined by the enveloping body 68 and receives the linear drive 2

The enveloping body 67 in particular has a tubular wall section 72 which peripherally delimits the enveloping body interior 68 and radially encompasses the linear drive 2 to the outside. Its length preferably corresponds to the length of the linear drive 2. The enveloping body 67, at least in its tubular wall section 72 preferably consists of a plastic material. It can be designed in a relatively thin-walled manner.

By way of example, the enveloping body 67 coming from the base structure 24 extends up to the opposite end region of the linear drive 2 which is assigned to the second housing end section 18b. It is evident from FIG. 1 that the enveloping body 67 can be open at the face side which is opposite the base structure 24, wherein in this case the enveloping body 67 as a whole can consist of the tubular wall section 72. The enveloping body 67 can however without further ado yet have at least one closure cover which closes the enveloping body interior 68 at the face side.

The enveloping body 67 is preferably fastened to a component of the linear drive 2 which is stationary with respect to the base structure 24. In this context, several fastening tabs 73 are evident in FIG. 3, via which fastening tabs the enveloping body 67 is attached to the fastening struts 25 of the linear drive 2. Additionally or alternatively, the enveloping body 67 can also be fastened directly to the base structure 24.

The enveloping body 67 has a longitudinal slot 74 which extends along the linear stroke path 37 of the driven section 36. This longitudinal slot 74 in particular is formed in the tubular wall section 72.

The interface module 4 is attached to the driven section 36 such that it projects through the longitudinal slot 74 of the enveloping body 67. Given the drive movement 8, the interface module 4 displaces along the longitudinal slot 74, whose length is dimensioned such that it does not block the linear stroke path of the interface module 4.

Expediently, the longitudinal slot 74 is shorter than the tubular wall section 72 of the enveloping body 67, so that the longitudinal slot 74 as a whole has the shape of an elongate window-like wall opening of the tubular wall section 72.

The interface module body 38 has an inner module body section 75 which is located in the inside of the enveloping body interior 68 and on which the first mechanical fastening interface 42 is formed.

The interface module body 38 furthermore has an outer module body section 76 which lies outside the enveloping body 67 and on which the second fastening location 43 is formed.

According to the illustrated preferred embodiment example, the inner module body section 75 has an inner fastening base 77, whilst the outer module body section 76 has an outer fastening base 78. The inner fastening base 77 comprises the first assembly surface 46, whereas the second assembly surface 47 is formed on the outer fastening base 78.

Both fastening bases 77, 78 are at least partially wider than the longitudinal slot 74 of the enveloping body 67 in the axis direction of the transverse axis 38c.

The two fastening bases 77, 78 are connected to one another as one piece by way of a connection web 82 of the interface module body 38. The connection web 82 extends through the longitudinal slot 74 and is relatively narrow in the axis direction of the transverse axis 38c, so that the slot width of the longitudinal slot 74 can also be designed in a very small manner. The connection web 82 preferably extends over the complete length of the interface body 38 which is measured in the axis direction of the longitudinal axis 38b.

The height of the connection web 82 which is measured in the axis direction of the height axis 38a is preferably larger than the wall thickness of the enveloping body 67 in the region which frames the longitudinal slot 74, so that an inner section of the connection web 82 belongs to the inner module body section 75 and an outer section of the connection web 82 to the outer module body section 76.

The interface module 4 apart from its fastening function preferably yet also has the function of a transmission of fluid pressure medium and of the electric current between the stationary constituents of the drive system 1 and of the working unit 3.

In this context, in a manner which is not represented further, at least one fluid transmission channel 92 and at least one electricity transmission channel 93 passes through the interface module body 38. Whereas only a single electricity transmission channel 93 is present by way of example, the embodiment example comprises two fluid transmission channels 92.

Each fluid transmission channel 92 runs out with an inner channel opening 92a at the inner module body section 75 and with an outer channel opening 92 at the outer module body section 76. Furthermore, each electricity transmission channel 93 runs out with an inner channel opening 93a at the inner module body section 75 and with an outer channel opening 93b at the outer module body section 76.

Expediently, an inner tube connection unit 94a is arranged on each inner channel opening 92a and is designed in order to be able to connect a flexible fluid tube which is suitable for leading a fluidic pressure medium, in a releasable manner In a comparable manner, an outer tube connection unit which is not visible in the figures is arranged on each outer channel opening 92b.

The fluid transmission channels in the interface module body 38 serve for leading through a fluidic pressure medium which is used for the operation of the at least one fluidic actuator device 65 of the working unit 3. The pressure medium comes from the pressure source P which is already mentioned further above and, inasmuch as an enveloping body 67 is present as with the embodiment example, is led within the enveloping body interior 68 through a bending-flexible fluid tube arrangement 95 onto the inner channel openings 92a of the interface module body 38.

The fluid tube arrangement 95 has an a length section which is to be denoted as an inner fluid tube section 85a and connects the inner channel openings 92a of the fluid transmission channels 92 to a stationary fluidic main connection device 17 which is connected on the one hand to the pressure source P and on the other hand to the pressure sink R. The inner fluid tube section 95a expediently extends exclusively in the enveloping body interior 68.

The fluidic main connection device 17 by way of example serves for the parallel fluid supply and fluid removal with regard to the linear drive 2 as well as the working unit 3. By way of example, the inner fluid tube section 95 as is shown can be branched form the valve connection channels 23a, 23b. The connection onto the inner channel openings 92a is effected by way of the inner tube connection units 94a which are attached thereto. Alternatively, the main connection device 17 can also be designed such that the control valve device 16 and the working unit 3 are connectable to the pressure source P and a pressure sink R independently of one another.

Given the drive movement 8, the inner tube connection units 94a move together with the interface module 4 whilst executing the drive movement 8. Herein, the inner fluid tube section 95a can bend in a flexible manner.

Outside the enveloping body 67, the bending-flexible fluid tube arrangement 95 continues with a separate length section which is denoted as an outer fluid tube section 95b and is connected at one end via the outer tube connection units 94b onto the outer channel openings 92b of the fluid transmission channels 92 and at the other end onto the fluidic working connection device 65 of the working unit 3. The bending-flexible fluid tube arrangement 95 is therefore composed of the inner fluid tube section 95a which is led onto the interface module 4 and of the outer fluid tube section 95b which leaves the interface module 4.

The bending-flexible fluid tube arrangement 95 preferably consists of two parallel fluid tube lines, wherein the inner fluid tube section 95a and the outer fluid tube section 95b are each composed of two functionally parallel individual bending-flexible fluid tubes. The fluidic pressure medium is fed from the pressure source P via the one fluid tube line and the discharge of the pressure medium to the pressure sink R via the other fluid tube line.

The electric electricity supply of the working unit 3 is effected by way of a bending-flexible electricity cable arrangement 97 which with a bending-flexible electricity cable arrangement 97a extends in the enveloping body interior 68 between the internal electronic control device 32 and the inner channel opening 93a of the electricity transmission channel 93 of the interface module 4. The inner electricity cable section 97a expediently extends exclusively in the enveloping body interior 68.

In contrast to the fluid tube arrangement 95, the electricity cable arrangement 97 however extends in a continuous manner also through the interface module body 38 and does not end until at the electrical working connection device 66 of the drive unit 3 outside the enveloping body 67.

The electric current is therefore led through the interface module 4 by way of the bending-flexible electricity cable arrangement 97 which is envisaged for leading electricity being laid through the electricity transmission channel 7.

The electricity cable arrangement 97 has a length section which is denoted as an outer electricity cable section 97b and which by way of example extends outside the enveloping body 67 between the interface module 4 and the working unit 3. An intermediate electricity cable section which connects the inner and the outer electricity cable section 97a, 97b extends through the electricity transmission channel of the interface module body 38 in a manner which is not illustrated. On the part of the internal electronic control device 32, the electricity cable arrangement 97 is preferably connected onto the supplementary control module 32 which is provided with the closed-loop control electronics 31.

The inner electricity cable section 97a of the bending-flexible electricity cable arrangement 97 can bend without any problem without assuming damage, given a linear movement of the interface module 4.

The bending-flexible electricity cable arrangement 97 expediently consists of a bending-flexible flexible bus cable which comprises the necessary number of electrically conductive cores, in order to be able to transmit the electrical current in a suitably processed form for the energy supply and/or for the electrical control.

The electricity cable arrangement 97 by way of example is designed with the electrical control lead 34 as a uniform control lead which is dragged through the supplementary control module 32. The electric control lead 34 here therefore is a length section of the bending-flexible electricity cable arrangement 97.

The inner fluid tube section 95a of the fluid tube arrangement 95 and the inner electricity cable 97a of the electricity cable arrangement 97 are expediently led through a support device 102 which has a longitudinal extension, is designed in a flexible manner transversely to its longitudinal extension and simultaneously develops a protective effect by way of it preventing uncontrolled movements of the fluid tube arrangement 95 and the electricity cable arrangement 97 and a clamping between parts which are moved relative to one another. Inasmuch as an enveloping body 67 is present, the protective device 102 is located within the enveloping body interior 68.

The support device 102 is preferably formed by a so-called drag chain 103 which also applies to the illustrated embodiment example.

The drag chain 103 has a multitude of chain links 104 which are rowed on one another in an articulated manner and which encompass an axially continuous chain cavity 105, through which a fluid tube arrangement 95 and the electricity cable arrangement 97 extend.

The drag chain 103 has a first fastening end 106, with which it is assembled in a stationary manner with respect to the drive housing 6, wherein the first fastening end 106 by way of example is attached to one of the two fastening struts 25. An axially opposite second fastening end 107 of the drag chain 103 is fastened to the inner module body section 75 of the interface module body 38. This inner module body section 75 for the attachment of the second fastening end 109 comprises a third mechanical fastening interface 108 which in particular is designed for screw fastening the second fastening end of the drag chain 103.

For example, the third fastening interface 108 comprises several fastening holes 109 which are designed as threaded holes and to which the second fastening end 107 is fixedly screwed by way of fastening screws 110.

The drag chain 103 expediently has a longitudinal course which is bent away at least once. According to the illustrations, it can be led around the interface module 4 once at the face side.

The chain cavity 105 is open at the two fastening ends 106, 107, in order to permit the entry and exit of the fluid tube arrangement 95 and the electricity cable arrangement 97.

The drive system 1 is designed to the extent that the internal electronic control device 32 with the participation of the closed-loop control electronics 31 can create a movement of the drive unit 7 which is closed-loop controlled in position. This movement which is closed-loop controlled in its position is effected in combination with a closed-loop control of the fluid pressure, said pressure prevailing in the drive chambers 13a, 13b of the linear drive 2 and being denoted as a drive pressure for an improved differentiation.

The enlarged framed detail in FIG. 2 which illustrates a preferred basic construction of one of each of the two control valve units 16a, 16b is referred to for explaining this closed-loop controlled operating manner

Accordingly, each control valve unit 16a, 16b is provided with a pressure sensor device 113 which detects the drive pressure which prevails in the connected drive chamber 13a, 13b and which is therefore denoted as a drive pressure sensor device 113. The pressure detection is preferably effected in the drive channel 14a, 14b which is connected to the related drive chamber 13a, 13b. Each drive pressure sensor device 113 is electrically connected to the internal electronic control device 32 via the electrical control lead 33 and in this manner can transmit electrical pressure signals which correspond to the measured drive pressure, to the internal electronic control device 32.

The drive pressure sensor devices 113 although preferably being integrated into the control valve device 16 however they can indeed also be placed outside the control valve device 16.

The drive system 1 furthermore comprises a displacement measuring device 114 which is assigned to the linear drive 2. The displacement measuring device 114 is capable of detecting the current stroke position of the drive unit 7 as the actual stroke position. The displacement measuring device 114 is connected onto the internal electronic control device 32 via an electrical signal lead 115 and in this manner is capable of transferring the electrical position signals which correspond to the actual stroke positions, to the internal electronic control device 32.

As with the drive pressure sensor devices 113, the displacement measuring device 114 is also expediently connected onto the supplementary control module 32b which is provided with the closed-loop control electronics 31.

The displacement measuring device 114 can operate in a digital or analogous manner Its function is preferably based on a contact-free and for example magneto-strictive or inductive measuring principle. Each current actual position of the drive unit 7 can be detected by the displacement measuring device 114 and transferred to the internal electronic control device 32 as an electrical potential signal.

On account of the closed-loop control electronics 31, the drive unit 7 can be positioned in an exact manner in the desired setpoint stroke positions which a control program which is contained in the internal electronic control device 32 generates, and/or can be set externally by the external electronic control device 35.

The closed-loop control of the position is effected in the context of a closed-loop control of the drive pressures which prevail in the drive chambers 13a, 13b, wherein the electrical pressure signals which are produced by the drive pressure sensor devices 113 are processed. The internal electronic control device 32 controls the two control valve units 16a, 16b such that the drive pressures can be closed-loop controlled to predefined setpoints

With the help of the closed-loop control of the pressure, the drive unit 7 can cover large path distances of its drive movement 8 at high speeds and despite this can be stopped at the sought desired stroke position in an accurate manner without any significant overshoots.

Longer stop times can be temporarily additionally mechanically fixed amid the supplementary cooperation of the initially mentioned locking brake. Irrespective of this, the locking brake can also be used as a safety feature for emergency braking procedures or also for the permanent blocking of a stroke position in the pressure-free state of the drive system 1. The brake control valve 15 which is then applied is expediently connected onto the internal electronic control device 32, by way of which it can be electrically controlled in accordance with requirements.

The displacement measuring device 114 expediently has a stator part 116 which is fixed in a stationary manner with respect to the drive housing 6 and which is designed for example in a strip-like manner It preferably extends parallel next to the drive housing 6. Furthermore, the displacement measuring device 114 expediently has a slider 117 which is movable along the stator part 116, is coupled in movement to the drive unit 7 and for determining the actual stroke position interacts with the stator part 116.

Expediently, the drive system 1 is also provided with a supply pressure sensor device 118 which detects the supply pressure of the fluidic pressure medium which is fed to the control valve device 16 from the main connection device 17. By way of example, an individual supply pressure sensor device 118 is assigned to each control valve device 16a, 16b. Each supply pressure sensor device 118 is connected to the internal electronic control device 32 via an electrical signal lead 119.

It is further advantageous if the drive system 1 comprises at least one fluid delivery pressure sensor device 120 which is capable of detecting the fluid pressure which is denoted as the fluid delivery pressure, of the fluidic pressure medium which flows back from the control valve device 16 to the main connection device 17. The fluid delivery pressure sensor device 120 is connected onto the internal electric control device 32 via an electrical signal lead 121 for transmitting the detected pressure values.

The supply pressure sensor device 118 and the fluid delivery pressure sensor device 120 by way of example are integrated into the control valve device 16 but can also be installed remotely of this. In particular they can also be contained in the main connection device 17 or built onto this.

The control valve device 16 is preferably a piezoelectric control valve device which relates to the illustrated embodiment example. By way of example, both control valve units 16a, 16b are designed as piezoelectric control valve units 16a, 16b and each comprise a plurality of electrically controllable and actuatable piezoelements 124.

The piezo-valves 124 as an actuator element or actuator elements in particular each comprise at least one piezoelectric bending transducer.

The actuation of the piezo-valves 124 as a rule demands a high-voltage control voltage. In order to generate this, the drive system 1 is expediently provided with a high-voltage stage 125 which is preferably integrated into the internal electronic control device 32, wherein it is preferably designed as a constituent of the supplementary control module 32b.

Each control valve unit 16a, 16b is expediently designed such that it can be operated with a 3/3-way valve function.

In order to realise this 3/3-way functionality, by way of example each control valve unit 16a, 16b is provided with an electrically actuatable supply valve unit 126 and with an electrically actuatable delivery valve unit 127. Both valve units 126, 127 have a 2/2 way valve function. The supply valve unit 126 is connected between at drive chamber 13a, 13b and the pressure source P and is capable of controlling the fluid feed to the respectively connected drive chamber 13a, 13b. The delivery valve unit 127 is connected between the same drive chamber 13a, 13b and the pressure sink R and is capable of controlling the fluid delivery from the respectively connected drive chamber 13a, 13b. Since the two valve units 126, 127 can be controlled independently of one another, the fluid pressure which prevails in the respectively connected drive chamber 13a, 13b can be closed-loop controlled in a very exact manner. The valve units 126, 127 which are contained in one and the same control valve unit 16a, 16b are expediently connected to the internal electronic control device 32 via one of the further electrical control leads 33 which have already been mentioned further above.

For encouraging a large throughflow, each valve unit 126, 127 can comprise a group of valves which are connected in parallel. By way of example, each supply valve unit 126 comprises two piezo-valves 124 and each delivery valve unit 127 comprises three piezo-valves 124. The piezo-valves 124 which are contained in the respective same valve group are preferably controlled always simultaneously and in the same direction by the internal electronic control device 32.

1. A drive system, comprising a linear drive which has a drive housing and a drive unit, wherein the drive unit is displaceable with respect to the drive housing in the axis direction of a longitudinal axis of the linear drive whilst carrying out a linear drive movement and is positionable in different stroke positions, wherein the drive unit comprises a driven section which is accessible outside the drive housing, moves along a linear stroke path given the drive movement and comprises an assembly interface which is designed for the attachment of a working unit which is linearly displaceable by the drive movement of the drive unit, and
(a) wherein the linear drive is a double-acting fluid-actuated linear drive whose drive unit comprises a drive piston which is arranged in the drive housing, is coupled in movement to the driven section and in the drive housing axially divides off two drive chambers from one another, said drive chambers being able to be subjected to a fluidic pressure medium in a controlled manner for moving and positioning the drive unit,
(b) that-wherein an electrically actuatable control valve device is arranged on the drive housing of the linear drive, said control valve device being designed for the controlled fluid subjection of the two drive chambers and on the one hand being in fluid connection with the two drive chambers of the linear drive each via a drive channel and on the other hand for the receiving and for the delivery of a fluid pressure medium communicating with a fluidic main connection device, said main connection device comprising a main fluid supply connection which is provided for connection to a pressure source and a main fluid delivery connection which is provided for connection to a pressure sink,
(c) wherein an internal electronic control device of the drive system which is electrically connected to the control valve device for control purposes is arranged on the drive housing of the linear drive,
(d) wherein two drive pressure sensor devices which are designed for detecting the fluid pressure which prevails in the two drive chambers and which for the transmission of electrical pressure signals are electrically connected to the internal electronic control device are present,
(e) wherein the linear drive is provided with a displacement measuring device which is suitable for detecting the momentary actual stroke position of the drive unit and which for the transmission of electrical position signals is electrically connected to the internal electronic control device,
(f) wherein the internal electronic control device comprises a closed-loop control electronics, by way of which the control valve device is electrically controllable in a closed-loop controlled manner with respect to pressure for the actuation of the drive unit in a closed-loop controlled manner with respect to position whilst taking into account the position signals which are delivered by the displacement measuring device and the pressure signals which are delivered by the two drive pressure sensor devices,
(g) wherein a bending-flexible electricity cable arrangement is connected onto the internal electronic control device, said electricity cable arrangement being designed for the electricity-transmitting electrical connection of the internal electric control device to at least one electrical actuator device of the working unit, said working unit being fastened to the assembly interface, and
(h) wherein a bending-flexible fluid tube arrangement which is designed for the fluid-transmitting fluidic connection of the fluidic main connection device to at least one fluidic actuator device of the working unit is connected onto the fluidic main connection device, said working unit being fastened to the assembly interface.

2. The drive system according to claim 1, further comprising a working unit which is attached to the assembly interface of the drive unit, said working unit comprising at least one fluidic actuator device which can be actuated by fluid force and which is connected to the bending-flexible fluid tube arrangement, and at least one electrically actuatable electrical actuator device which is connected to the bending-flexible electricity cable arrangement.

3. The drive system according to claim 2, wherein at least one fluidic actuator device of the working unit is a fluid-actuated rotary drive and/or wherein at least one electrical actuator device of the working unit is a valve or a valve drive which belongs to a control valve device of the working unit.

4. The A drive system according to claim 1, further comprising an interface module which is fastened with a first mechanical fastening interface to the assembly interface of the driven section of the drive unit and with a second mechanical fastening interface is fastened to the drive unit, to which interface module the bending-flexible fluid tube arrangement as well as the bending-flexible electricity cable arrangement is fixed.

5. The drive system according to claim 1, wherein the linear drive is a pneumatic linear drive which is operated with pressurised air as a fluidic pressure medium.

6. The drive system according to claim 1, wherein the linear drive is of the piston rod-less type, wherein the drive piston with regard to drive is coupled through a peripheral housing wall of the drive housing to the driven section which is arranged outside the drive housing.

7. The drive system according to claim 1, wherein the bending flexible electricity cable arrangement and the bending-flexible fluid tube arrangement are fed through a support device which at one end is fastened in a stationary manner with respect to the drive housing of the linear drive and at the other end in a stationary manner with respect to the driven section of the drive unit, said support device being flexible transversely to its longitudinal direction.

8. The drive system according to claim 1, wherein the internal electronic control device comprises an electric communication interface for connection to an external electronic control device.

9. The drive system according to claim 1, wherein the control valve device is a piezoelectric control valve device which is provided with a plurality of electrically controllable piezo-valves, wherein the internal electronic control device comprises a high-voltage stage for producing a high-voltage operating voltage for the piezo-valves.

10. The drive system according to claim 1, wherein the control device comprises two separate control valve units which are each fastened to the drive housing in the region of one of the two axial housing end sections and each via one of the two drive channels which pass through the drive housing are fluidically connected onto one of the two drive chambers in a manner such that each drive chamber is fluidically controllable by an individual control valve unit.

11. The drive system according to claim 10, wherein each control valve unit comprises an electrically actuatable supply valve unit for the control of the fluid feed to the connected drive chamber and an electrically actuatable delivery valve unit for the control of the fluid delivery from the connected drive chamber, said valve units each having a 2/2-way valve function and with regard to operation being able to be controlled independently of one another by the internal electronic control device in a manner such that each control valve unit can be operated with a 3/3-way valve function.

12. The drive system according to claim 1, wherein the internal electronic control device comprises a main control module and a supplementary control module which is separate with respect to the main control module and is electrically connected to the main control module, wherein the closed-loop control electronics is contained in the supplementary control module.

13. The drive system according to claim 1, further comprising at least one supply pressure sensor device which detects the supply pressure of the fluidic pressure medium which is fed from the main connection device to the control valve device, and which for the transmission of electrical pressure signals is electrically connected to the internal electronic control device.

14. The drive system according to claim 1, further comprising at least one fluid delivery pressure sensor device which detects the fluid delivery pressure of the fluidic pressure medium which is delivered from the control valve device onto the main connection device and which for the transmission of electrical pressure signals is electrically connected to the internal electronic control device.

15. The drive system according to claim 1, wherein the drive system, wherein the working unit is a robot arm of the robot.

16. The drive system according to claim 6, wherein the drive piston with regard to drive is coupled to the driven section by a driver section of the drive unit which passes through a longitudinal slot of the peripheral housing wall of the drive housing.

17. The drive system according to claim 7, wherein the support device is formed by a drag chain.

18. The drive system according to claim 8, wherein, by way of the external electronic control device, a desired stroke position of the drive unit, which is to be taken into account by the closed-loop control electronics, can be specified.

19. The drive system according to claim 8, wherein the external electronic control device is a constituent of the drive system.

20. The drive system according to claim 12, wherein a high-voltage stage for generating a high-voltage operating voltage for piezoelements of the control valve device is contained in the supplementary control module.
